(19) United States
(12) Patent Application Publication
(10) Pub. No.: US 2026/0002353 A1
(43) Pub. Date: Jan. 1, 2026

(54) CONSTRUCTION METHOD OF MODULAR SHEAR WALLS BASED ON DOUBLE-FACE SUPERPOSED SHEAR WALL

(71) Applicant: CHINA CONSTRUCTION FOURTH ENGINEERING DIVISION CORP. LTD, GUANGZHOU (CN)

(72) Inventors: CHENGUANG HUANG, GUANGZHOU (CN); YANXIN ZHANG, GUANGZHOU (CN); ZILU ZHOU, GUANGZHOU (CN); KAI CHEN, GUANGZHOU (CN); ZHENGRONG GUI, GUANGZHOU (CN); YUDE LIANG, GUANGZHOU (CN); CHUNJIAN LIN, GUANGZHOU (CN); ZAICHEN ZHANG, GUANGZHOU (CN); YINGJIAN HUANG, GUANGZHOU (CN)

(73) Assignee: CHINA CONSTRUCTION FOURTH ENGINEERING DIVISION CORP. LTD, GUANGZHOU (CN)

(21) Appl. No.: 19/007,507

(22) Filed: Jan. 1, 2025

(30) Foreign Application Priority Data
Jun. 28, 2024 (CN) 202410857672.8

(51) Int. Cl. E04B 1/348

(52) U.S. Cl. CPC E04B 1/34853

(57) ABSTRACT

The present disclosure discloses a construction method of a modular shear wall based on a double-face superposed shear wall, including obtaining relevant parameter information; calculating the size of adjustment gaskets according to the obtained relevant parameter information; and then determining the relationship between the levelness on site and the preset standard level, if the levelness on site is greater than the preset standard level, then outputting a first result, otherwise, outputting a second result, the first result is used to guide a construction personnel to calibrate the levelness on site by adjusting the adjustment gasket, the second result is used to control a display to show the installation position and design size of the shear wall, and instruct the construction personnel to operate according to the information shown on the display.

### TECHNICAL FIELD

The present disclosure belongs to the technical field of prefabricated construction, and in particular to a construction method of modular shear walls based on double-face superposed shear wall.

### BACKGROUND

The present disclosure proposes a structural design of modular shear wall based on double-face superposed shear wall and a construction method thereof in terms of safety and cost. Modular integrated buildings naturally feature standardized design, industrial production, assembly construction and so on, which can reduce environmental pollution, improve labor productivity and improve quality and safety level, so modular construction is the key to the construction of high-quality houses.

Double-face superposed shear wall has a mature standard system and is widely used, especially in high-rise residential buildings owing to its high safety.

The production capacity of the prefabricated components of double-face superposed shear wall in the market is gradually increased, but most of them are used as separate components, and are rarely used in the field of modular integrated buildings. In view of this phenomenon, we propose a construction method of modular shear walls based on double-face superposed shear walls, which can make full use of existing production lines and production capacity, reduce costs, and provide a new construction solution for modular integrated buildings.

### SUMMARY

The present disclosure provides a construction method of a modular shear wall based on a double-face superposed shear wall, which can effectively solve the above problems.

The present disclosure proposes the following solutions.

A construction method of a modular shear wall based on double-face superposed shear wall comprises:
acquiring installation information on site and design information of a shear wall module, wherein the installation information on site includes the size of an adjustment gasket on site and a levelness on site, and the design information includes a designed size of each component of a shear wall;
calculating the size of the adjustment gasket according to the designed size of each component of the shear wall and a maximum loading capacity of the adjustment gasket per unit;
determining a relationship between the levelness on site and a preset standard levelness, if the levelness on site is greater than the preset standard levelness, outputting a first result, otherwise, outputting a second result, wherein the first result is used to guide construction personnel to calibrate the levelness on site by adjusting the adjustment gasket, so as to make the levelness on site less than or equal to the preset standard levelness, the second result is used to control a display to show an installation position and a designed size of the shear wall, and instruct the construction personnel to operate according to information shown on the display.

As a further improvement, the step of outputting the second result, wherein the second result is used to control the display to show the installation position and the designed size of the shear wall, and instruct the construction personnel to operate according to the information shown on the display, further comprising:
sending the designed size of each component of the shear wall to a manufacturer's server to instruct the manufacturer to produce each component of the shear wall;
obtaining a first manufacturing error of each component of the shear wall according to an actual size of each component of the shear wall and the designed size of each component of the shear wall;
determining whether the first manufacturing error meets a requirement, if yes, sending a first control command, wherein the first control command includes an instruction of controlling the display to show information that each component of the shear wall is qualified for installation.

As a further improvement, after the step of sending the first control command, wherein the first control command includes the instruction of controlling the display to show information that each component of the shear wall is qualified for installation, the method further comprises:
installing the components of the shear wall on a large formwork platform, and leveling and reinforcing the installation through a fixation adjustment fixture, wherein the installation of the components of the shear wall includes a lap joint of sidewalls and a bottom plate, a lap joint of the sidewalls and a top plate, and a connection between the sidewalls, and the connection between the sidewalls includes a connection of a first double-face superposed shear wall and a bay window, a connection of the first double-face superposed shear wall and a second double-face superposed shear wall, a splicing of the second double-face superposed shear wall and a first single-piece wall, a splicing of the first single-piece wall and a second single-piece wall, and a splicing of the second single-piece wall and the first double-face superposed shear wall;
after the installation of the components is completed, sending a second control command, wherein the second control command includes an instruction to control the display to show that the installation of the components of the shear wall is completed and on-site assembling is permitted.

As a further improvement, steel plates are pre-embedded around a window opening of the first double-face superposed shear wall, and steel plates are also pre-embedded in a recess of the bay window; the bay window and the first double-face superposed shear wall are installed in place and are fixed by welding the steel plates of the first double-face superposed shear wall and the bay window; the ends of an indoor side of an inner wall of the first double-face superposed shear wall and the second double-face superposed shear wall are respectively pre-embedded with full-length steel plates along its height in vertical direction, and the first double-face superposed shear wall and the second double-face superposed shear wall are fixed by welding the pre-embedded steel plates; the second double-face superposed shear wall is connected with the first single-piece wall by welding the full-length steel plates pre-embedded in the ends of an outdoor side, the first single-piece wall is connected with the second single-piece wall by welding the full-length steel plates pre-embedded in the ends of the outdoor side, and the second single-piece wall is connected to the first double-face superposed shear wall by welding the full-length steel plates pre-embedded in the ends of an outdoor side.

As a further improvement, bent steel bars for a lap joint extend out from a bottom part of the first single-piece wall and the second single-piece wall, and the bent steel bars are fixed with the steel bars of a bottom plate by the lap joint.

As a further improvement, straight steel bars for the lap joint extend out from the first double-face superposed shear wall and the second double-face superposed shear wall, and bottom parts of the first double-face superposed shear wall and the second double-face superposed shear wall are respectively provided with grooves. After the first double-face superposed shear wall and the second double-face superposed shear wall are manufactured, the steel bars for the lap joint are bent, the first double-face superposed shear wall and the second double-face superposed shear wall are respectively connected to a group of bottom plates, and the two groups of bottom plates are formed by secondary concrete pouring.

As a further improvement, steel plates are arranged at intervals of 600 mm-800 mm on a top part of the sidewall and around ends of the top plate. To install the top plate, a fixed adjustment fixture is configured to provide support for the top plate, after the steel plates on the top part of the sidewall are welded with the steel plates around the ends of the top plate, the fixed adjustment fixture is removed to assemble the shear wall.

As a further improvement, an interior of the shear wall is provided with an ALC partition wall, and the bottom plate at a position where the ALC partition wall is installed is provided with a flashing.

As a further improvement, the step of sending the second control command, wherein the second control command includes an instruction to control the display to show that the installation of the components of the shear wall is completed and on-site assembling is permitted further includes:
adjusting the elevation of the installation position of the shear wall by adjusting the adjustment gasket and arranging a bed-mortar layer on the installation position of the shear wall, wherein a range of the bed-mortar layer is a region of projection of the sidewall of the shear wall; installing the shear wall from a corewall to the outside in a radiative manner; then assembling U-shaped steel bars and placing a running surface; wherein two rows of connection steel plates are respectively preset between a left group and a right group of shear walls, and anchor bars of the two rows of connection steel plates penetrate deep into the interior of the shear walls, the two rows of connection steel plates are vertically lowered while the left group and right group of shear walls are installed without mutual interference, after the two rows of connection steel plates are installed in place, a gap ranged 20 mm-30 mm is left between the left group and right group of shear walls, the two rows of connection steel plates are correspondingly provided with pin holes, and pins are inserted into the pin holes along the gap to establish a double steel plate pin joint node, and staggered annular stirrups are preset in inner wall joint nodes of a combination of the left group and right group of shear walls, and a row of tie screws are added per 1000 mm-12000 mm to form a staggered annular stirrup connecting tie joint.

As a further improvement, an upper group and a lower group of shear walls are connected by long U-shaped reinforcement bars arranged at intervals, an open end of each long U-shaped reinforcement bar faces downward, and short U-shaped reinforcement bars are supplemented in addition to the long U-shaped reinforcement bars, an open end of each short U-shaped reinforcement bar faces upward, and straight reinforcement bars are provided at an inner side of the short U-shaped reinforcement bars, and the straight reinforcement bars pass through a plurality groups of the short U-shaped reinforcement bars.

An edge component at the corner of each shear wall comprises two double-face superposed shear walls, stirrups are preset at end parts of the two double-face superposed shear walls, the stirrups of the two double-face superposed shear walls are overlapped and joined together, and the two double-face superposed shear walls are spliced together by welding preset steel plates, wherein an overlapping area of the stirrups of the two double-face superposed shear walls is provided with a full-length connecting U-shaped reinforcement bar.

The stirrups at the coupling beams of the two groups of shear walls are staggered, and the stirrups on beam surfaces of the coupling beams are assembled beforehand before leaving the factory, after installation of the two groups of shear walls, additional steel bars are arranged at intervals at the coupling beams of the top plate.

The present disclosure has the following advantages.

1. The shear wall as a whole is leveled by the adjustment gasket, thereby ensuring the stability of the shear wall during installation.

2. The method of the present disclosure can realize intelligent construction and is more accurate in analyzing relevant parameters and calculating corresponding results, thereby avoiding errors that may occur in manual calculations.

3. By making the building modules configurable, the modules are designed as components and assembled in the factory. Compared with the integrally cast modules, the method of the present disclosure makes full use of the existing production line of the double-face superposed shear walls to realize flow line production and improve labor productivity.

4. The present disclosure adopts double steel plate pin joint node which can address the problem that the edge limiting components of the shear wall cannot realize formwork-free operation and the over-thick wall. In conventional modular integrated building, the space for the edge limiting components is reserved to be concreted on site with formwork. If formwork-free operation is required, the thickness of the wall needs to be increased.

5. The present disclosure adopts the staggered annular stirrup connecting tie joint to solve the problem that the formwork of the inner wall cannot work collaboratively in load bearing when the modular building is disassembled, thereby causing over thick of the inner wall.

### BRIEF DESCRIPTION OF THE DRAWINGS

In order to more clearly illustrate the technical solutions of the embodiments of the present disclosure, the drawings required for illustrating the embodiments are briefly introduced below. It should be understood that the following drawings only illustrate a part of embodiments of the present disclosure and should not be regarded as limiting the scope of the present disclosure. For those of ordinary skill in the art, other related drawings may be obtained based on these drawings without creative efforts.

FIG. 1 is an exploded view of an overall structure of the shear walls of the present disclosure.

FIG. 2 is an installation diagram of the overall structure of the shear walls of the present disclosure.

FIG. 3 is a schematic diagram showing a joint node of a first double-face superposed shear wall and a bay window of the present disclosure.

FIG. 4 is a schematic diagram showing a joint node of a first double-face superposed shear wall and a second double-face superposed shear wall of the present disclosure.

FIG. 5 is a schematic diagram showing a joint node of a first single-piece wall and a second single-piece wall of the present disclosure.

FIG. 6 is a schematic diagram showing a joint node of the first single-piece wall and a bottom plate of the present disclosure.

FIG. 7 is a schematic diagram showing a joint node of a second double-face superposed shear wall and the bottom plate of the present disclosure.

FIG. 8 is a schematic diagram showing a joint node of a top plate and a sidewall of the present disclosure.

FIG. 9 is a schematic diagram showing a connection node of a group of left shear wall and a group of right shear wall that are adjacent to each other of the present disclosure.

FIG. 10 is a schematic diagram showing a connection node of inner walls of the group of left shear wall and the group of right shear wall that are adjacent to each other of the present disclosure.

FIG. 11 is a schematic diagram showing a connection node of the outer walls of the group of left shear wall and the group of right shear wall that are adjacent to each other of the present disclosure.

FIG. 12 is a schematic diagram showing a connection node of the coupling beams of a group of upper shear wall and a group of lower shear wall of the present disclosure.

FIG. 13 is an installation diagram of multiple groups of shear walls of the present disclosure.

Reference numerals used in the drawings are listed below:
1—first double-face superposed shear wall, 2—bay window, 3—second double-face superposed shear wall, 4—first single-piece wall, 5—second single-piece wall, 6—bottom plate, 7—top plate, 8—ALC partition wall, 9—flashing, 10—fixed adjustment fixture, 11—large formwork platform, 12—steel bars for lap joint, 13—groove, 14—pin, 15—tie screw, 16—long U-shaped reinforcement bar, 17—annular stirrup, 18—short U-shaped reinforcement bar, 19—supplemental steel bar, 20—stirrup, 21—connection steel plate, 22—waterproof pressure groove, 23—waterproof groove.

### DETAILED DESCRIPTION OF THE EMBODIMENTS

To make the objectives, technical solutions and advantages of the embodiments of the present disclosure clearer, the technical solutions in the embodiments of the present disclosure will be clearly and completely described below in conjunction with the accompanying drawings for illustrating the embodiments of the present disclosure. Obviously, the described embodiments are part of the embodiments of the present disclosure rather than all. Based on the embodiments of the present disclosure, all other embodiments obtained by those of ordinary skill in the art without creative efforts should all be considered as falling within the scope of protection of the present disclosure. Therefore, the following detailed description of the embodiments of the present disclosure illustrated in the accompanying drawings is not intended to limit the scope of the invention sought to be patented, but merely represents the selected embodiments of the present disclosure.

In the description of the present disclosure, the terms “upper”, “under/below”, “upper/above”, “both ends”, and so on for indicating the orientation or position relationship are based on the orientation or position relationship shown in the accompanying drawings, which are only intended to facilitate the description of the present disclosure and for simplification purpose, rather than indicating or implying that the device or element referred to must have a specific orientation, be constructed and operated in a specific orientation, and therefore cannot be understood as limiting the present disclosure.

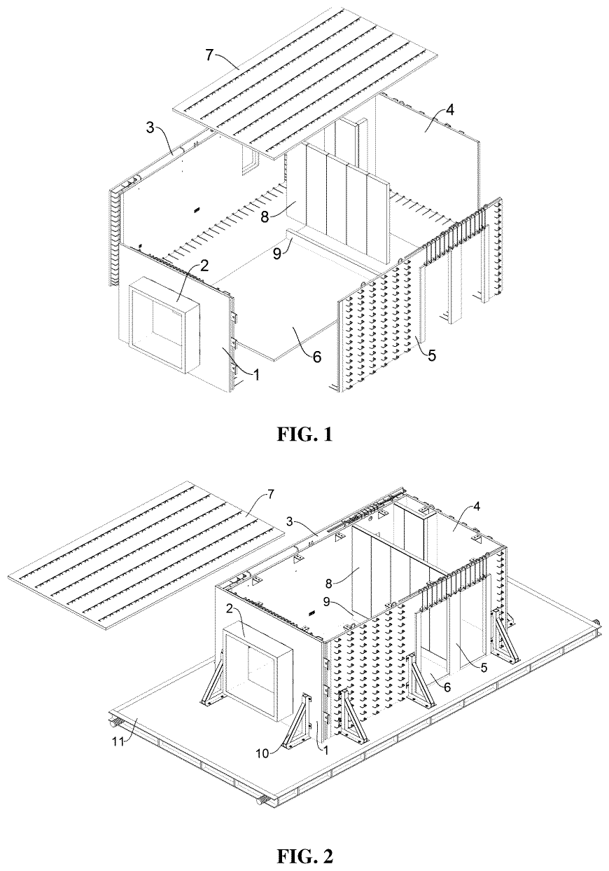

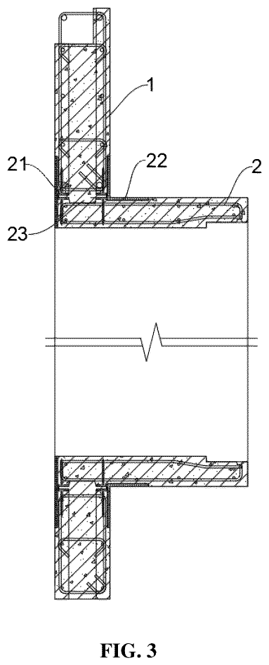

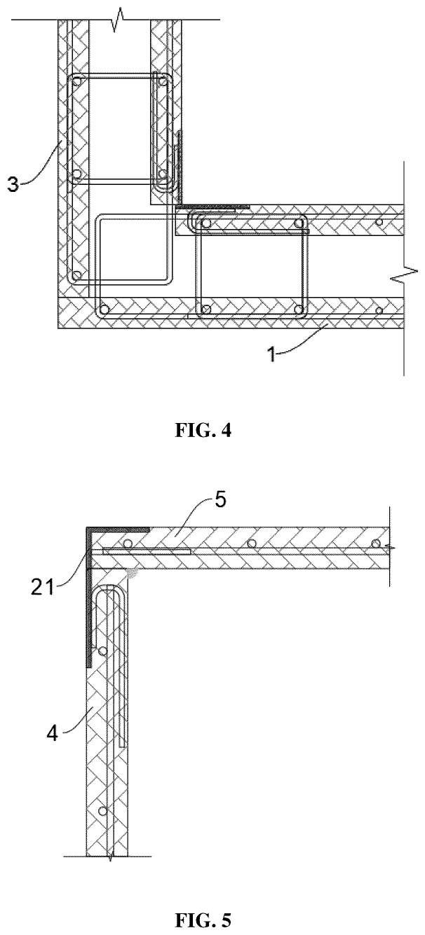

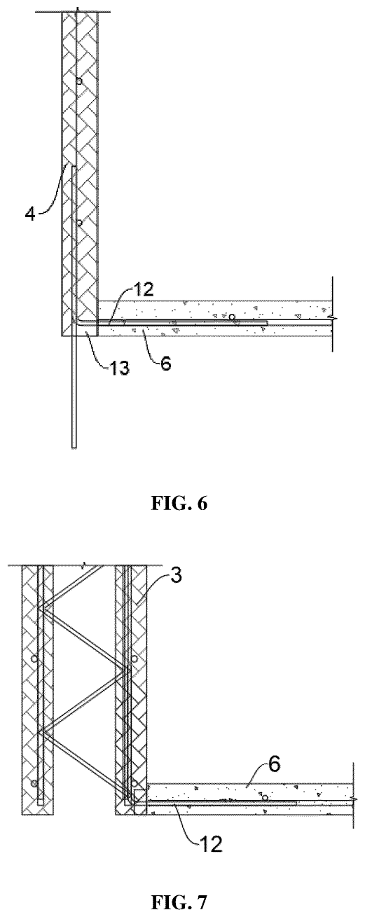

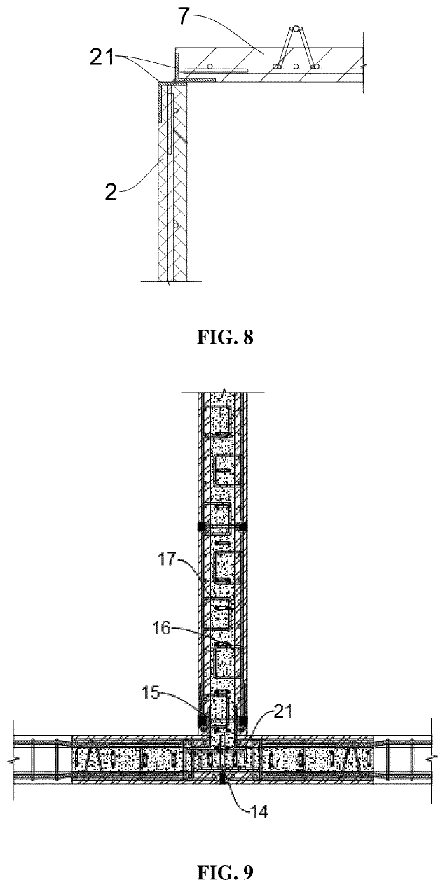

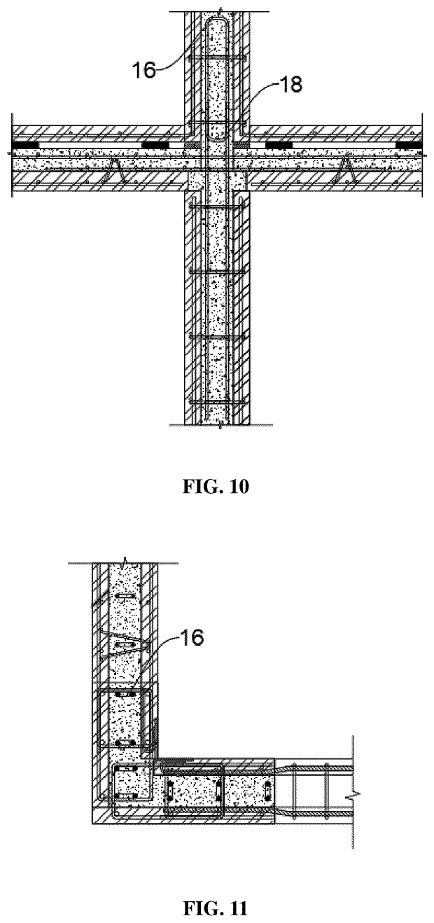

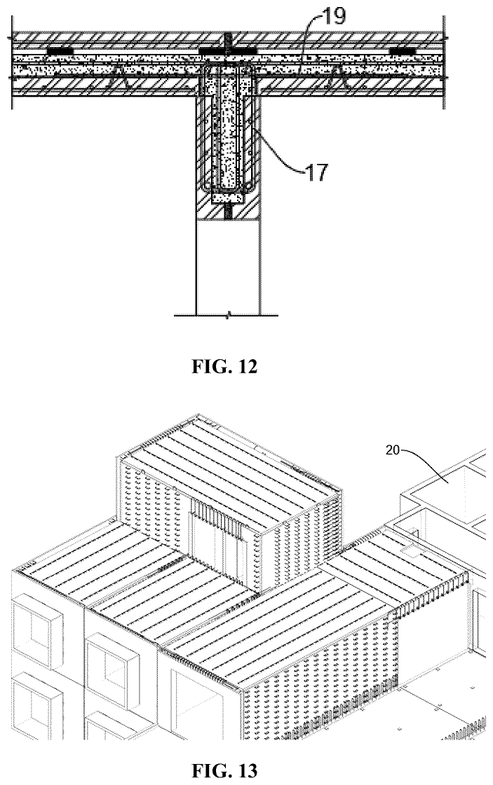

Referring to FIGS. 1-13, this embodiment provides a construction method of a modular shear wall based on double-face superposed shear wall, comprising:
acquiring installation information on site and design information of shear wall modules, wherein the installation information includes the size of an adjustment gasket on site and a levelness on site, and the design information includes a designed size of each component of a shear wall;
calculating the size of the adjustment gasket according to the designed size of each component of the shear wall and a maximum loading capacity of the adjustment gasket per unit;
determining a relationship between the levelness on site and a preset standard levelness, if the levelness on site is greater than the preset standard levelness, outputting a first result, otherwise, outputting a second result, wherein the first result is used to guide construction personnel to calibrate the levelness on site by adjusting the adjustment gasket, so as to make the levelness on site less than or equal to the preset standard levelness, the second result is used to control a display to show an installation position and a designed size of the shear wall, and instruct the construction personnel to operate according to information shown on the display.

Further, the step of outputting the second result, wherein the second result is used to control the display to show the installation position and the designed size of the shear wall, and instruct the construction personnel to operate according to the information shown on the display, further comprising:
sending designed size of each component of the shear wall to a manufacturer's server to instruct the manufacturer to produce each component of the shear wall;
obtaining a first manufacturing error of each component of the shear wall according to an actual size of each component of the shear wall and the designed size of each component of the shear wall;
determining whether the first manufacturing error meets a requirement, if yes, sending a first control command, wherein the first control command includes an instruction of controlling the display to show information that each component of the shear wall is qualified for installation.

The method of the present disclosure can realize intelligent construction and is more accurate in analyzing relevant parameters and calculating corresponding results, thereby avoiding errors that may occur in manual calculations. Further, the shear wall as a whole is leveled by the adjustment gasket, thereby ensuring the stability of the shear wall during installation.

Furthermore, after the step of sending the first control command, wherein the first control command includes the instruction of controlling the display to show information that each component of the shear wall is qualified for installation, the method further comprises:
installing the components of the shear wall on a large formwork platform 11, and leveling and reinforcing the installation through a fixation adjustment fixture 10, wherein the installation of the components of the shear wall includes a lap joint of sidewalls and a bottom plate 6, a lap joint of the sidewalls and a top plate 7, and a connection between the sidewalls, and the connection between the sidewalls includes a connection of a first double-face superposed shear wall 1 and a bay window 2, a connection of the first double-face superposed shear wall 1 and a second double-face superposed shear wall 3, a splicing of the second double-face superposed shear wall 3 and a first single-piece wall 4, a splicing of the first single-piece wall 4 and a second single-piece wall 5, and a splicing of the second single-piece wall 5 and the first double-face superposed shear wall 1;
after the installation of the components is completed, sending a second control command, wherein the second control command includes an instruction to control the display to show that the installation of the components of the shear wall is completed and on-site assembling is permitted.

The shear walls of the present disclosure are all designed as double-face superposed shear wall, and the bay window 2 is separated with the wall, which can solve the problems of cost increase of mould and low production efficiency caused by irregular structural component.

Furthermore, steel plates are pre-embedded around a window opening of the first double-face superposed shear wall 1, and steel plates are also pre-embedded in a recess of the bay window 2; the bay window 2 and the first double-face superposed shear wall 1 are installed in place and are fixed by welding the steel plates of the first double-face superposed shear wall 1 and the bay window 2; the ends of an indoor side of an inner wall of the first double-face superposed shear wall 1 and the second double-face superposed shear wall 3 are respectively pre-embedded with full-length steel plates along its height in vertical direction, and the first double-face superposed shear wall 1 and the second double-face superposed shear wall 3 are fixed by welding the pre-embedded steel plates; the second double-face superposed shear wall 3 is connected with the first single-piece wall 4 by welding the full-length steel plates pre-embedded in the ends of an outdoor side, the first single-piece wall 4 is connected with the second single-piece wall 5 by welding the full-length steel plates pre-embedded in the ends of the outdoor side, and the second single-piece wall 5 is connected to the first double-face superposed shear wall 1 by welding the full-length steel plates pre-embedded in the ends of an outdoor side.

The present disclosure uses steel plates for welding connection to reduce the risk of indoor welding that may affect the decoration.

Furthermore, bent steel bars 12 for a lap joint extend out from a bottom part of the first single-piece wall 4 and the second single-piece wall 5, and the bent steel bars are fixed with the steel bars of a bottom plate 6 by the lap joint.

Furthermore, straight steel bars 12 for the lap joint extend out from the first double-face superposed shear wall 1 and the second double-face superposed shear wall 3. After the first double-face superposed shear wall 1 and the second double-face superposed shear wall 3 are manufactured, the steel bars 12 for the lap joint are bent, and bottom parts of the first double-face superposed shear wall 1 and the second double-face superposed shear wall 3 are respectively provided with grooves 13. the first double-face superposed shear wall 1 and the second double-face superposed shear wall 3 are respectively connected to a group of bottom plates 6, and the two groups of bottom plates 6 are formed by secondary concrete pouring.

Furthermore, steel plates are arranged at intervals of 600 mm-800 mm on a top part of the sidewall and around ends of the top plate 7. To install the top plate 7, a fixed adjustment fixture 10 is configured to provide support, after the steel plates on the top part of the sidewall are welded with the steel plates around the ends of the top plate 7, the fixed adjustment fixture 10 is removed to assemble the shear wall.

By making the building modules configurable, the modules are designed as components and assembled in the factory. Compared with the integrally cast modules, the method of the present disclosure makes full use of the existing production line of the double-face superposed shear walls to realize flow line production and improve labor productivity.

Furthermore, an interior of the shear wall is provided with an ALC partition wall 8, and the bottom plate 6 at a position where the ALC partition wall 8 is installed is provided with a flashing 9.

By configuring the flashing 9 at the position where the ALC partition wall 8 is installed, the risk of water leakage in the bathroom is reduced.

Further, the step of sending the second control command, wherein the second control command includes an instruction to control the display to show that the installation of the components of the shear wall is completed and on-site assembling is permitted further includes:
adjusting the elevation of the installation position of the shear wall by adjusting the adjustment gasket and arranging a bed-mortar layer on the installation position of the shear wall, wherein a range of the bed-mortar layer is a region of projection of the sidewall of the shear wall; installing the shear wall from a corewall to the outside in a radiative manner; then assembling U-shaped steel bars and placing a running surface; wherein two rows of connection steel plates 21 are respectively preset between a left group and a right group of shear walls, and anchor bars of the two rows of connection steel plates 21 penetrate deep into the interior of the shear walls, the two rows of connection steel plates 21 are vertically lowered while the left group and right group of shear walls are installed without mutual interference, after the two rows of connection steel plates 21 are installed in place, a gap ranged 20 mm-30 mm is left between the left group and right group of shear walls, the two rows of connection steel plates 21 are correspondingly provided with pin holes, and pins 14 are inserted into the pin holes along the gap to establish a double steel plate pin joint node, and staggered annular stirrups 17 are preset in inner wall joint nodes of a combination of the left group and right group of shear walls, and a row of tie screws 15 are added per 1000 mm-12000 mm to form a staggered annular stirrup connecting tie joint.

According to the present disclosure, the pin 14 is inserted into the pin hole to form a double steel plate pin joint node, thereby ensuring the shear resistance between the left and right shear walls. Whilst, in order to ensure the ductility of the edge components of the shear wall, staggered annular stirrups 17 are preset in the inner wall nodes of the combination of the left and right groups of shear walls, and a row of tie screws 15 are added at intervals of 1000 mm-12000 mm, thereby forming the staggered annular stirrups connecting tie joint, which ensures that the left and right groups of shear walls can fall vertically while the tie screws 15 ensure the overall stability of the inner wall.

The present disclosure adopts double steel plate pin joint node which can address the problem that the edge limiting components of the shear wall cannot realize formwork-free operation and the over-thick wall. In conventional modular integrated building, the space for the edge limiting components is reserved to be concreted on site with formwork. If formwork-free operation is required, the thickness of the wall needs to be increased.

Further, an upper group and a lower group of shear walls are connected by long U-shaped reinforcement bars 16 arranged at intervals, an open end of each long U-shaped reinforcement bar 16 faces downward, and short U-shaped reinforcement bars 18 are supplemented in addition to the long U-shaped reinforcement bars 16, an open end of each short U-shaped reinforcement bar 18 faces upward, and straight reinforcement bars are provided at an inner side of the short U-shaped reinforcement bars 18, and the straight reinforcement bars pass through a plurality groups of the short U-shaped reinforcement bars 18.

An edge component at the corner of each shear wall comprises two double-face superposed shear walls, stirrups 20 are preset at end parts of the two double-face superposed shear walls, the stirrups 20 of the two double-face superposed shear walls are overlapped and joined together, and the two double-face superposed shear walls are spliced together by welding the preset steel plates, wherein an overlapping area of the stirrups 20 of the two double-face superposed shear walls is provided with a full-length connecting U-shaped reinforcement bar.

The stirrups 20 at the coupling beams of the two groups of shear walls are staggered, and the stirrups 20 on beam surfaces of the coupling beams are assembled beforehand before leaving the factory, after installation of the two groups of shear walls, additional steel bars 19 are arranged at intervals at the coupling beams of the top plate 7.

In the present embodiment, a waterproof pressure groove 22 is further provided at the joint between the double-face superposed shear wall and the bay window. A polymer waterproof mortar layer with a thickness of 5 mm is scraped and compacted by layer on the innermost part of the waterproof groove 22, and then anti-crack polymer mortar with a thickness of 5 mm thick is used in combination with an alkali-resistant glass fiber mesh to establish a second waterproofing layer. Finally, the outer surface of the prefabricated exterior wall is repaired and cleaned by reinforced concrete to achieve the waterproof property of the bay window 2. A waterproof groove 23 is also provided inside the bay window 2 and the double-face superposed shear wall 1. The waterproof groove 23 extends the water flow path of the bay window 2, thereby ensuring the waterproof performance of the bay window 2 and the double-face superposed shear wall 1.

In this embodiment, the construction of the double steel plate pin joint node and the staggered annular stirrup connecting tie joint may specifically include the following steps.

S1, prefabrication of shear walls in factory: when placing concrete to connect the two groups of shear walls, the vertical stress-bearing steel bars, horizontal stress-bearing steel bars, and annular stirrups 17 need to be assembled or welded according to design requirements, and connection holes are preset accordingly.

S2, before the installation of the shear wall: before the shear wall is hoisted, the shear wall should be measured and marked as a whole, and installation positioning marks and alignment ink lines should be drawn on the entire single shear wall, the position of the corresponding building plane and elevation should be re-measured, and the structural surface elevation of the supporting module should be reviewed for acceptance.

S3, during the installation of the shear wall: during the installation of the shear wall, an adjustment gasket should be set between the bottom of the shear wall and the concrete floor slab, and the adjustment gasket should be placed at the part with greater rigidity of the shear wall, both groups of shear walls can be lowered vertically, and the exposed annular stirrups 17 of the shear wall form an effective lap joint with the exposed annular stirrups 17 of the adjacent shear wall during the installation of the shear wall.

S4, installation of the tie screws 15: after the shear wall is installed in place and before the concrete is poured on site, the tie screws 15 are inserted into the reserved truncated cone-shaped pin holes of the connecting steel plates 21 of the two groups of shear walls to prevent the two groups of shear walls from cracking when pouring concrete into the cavity, thereby enhancing the horizontal compressive strength of the shear wall, and improving the structural rigidity and seismic performance of the shear wall as the permanent reinforcement tie bars. After the tie screws 15 are installed, the reserved truncated cone-shaped pin holes are grouted and filled to form a reliable connection, and the next step is carried out after the grouting solidifies.

S5, cast-in-situ concrete pouring and vertical connection bar arrangement: after the tie screws 15 are installed, a concrete cast wall is formed in the cavity of the gap between the two groups of shear walls. At the same time, short U-shaped reinforcement bars 18 and long U-shaped reinforcement bars 16 are arranged in the concrete cast wall to connect the longitudinal reinforcement bars of the upper and lower groups of shear walls and meet the horizontal shear resistance requirements at the joints.

The above description merely includes preferred embodiment of the present disclosure, and is not intended to limit the present disclosure. For those skilled in the art, the present disclosure may have various changes and variations. Any modification, equivalent substitution, improvement, and so on made within the spirit and principles of the present disclosure should be included within the protection scope of the present disclosure.

What is claimed is:

1. A construction method of a modular shear wall based on double-face superposed shear wall comprising:
acquiring installation information on site and design information of a shear wall module, wherein the installation information on site comprises a size of an adjustment gasket on site and a levelness on site, and the design information comprises a designed size of each component of a shear wall;
calculating the size of the adjustment gasket according to the designed size of each component of the shear wall and a maximum loading capacity of the adjustment gasket per unit; and
determining a relationship between the levelness on site and a preset standard levelness, if the levelness on site is greater than the preset standard levelness, outputting a first result, otherwise, outputting a second result, wherein the first result is used to guide a construction personnel to calibrate the levelness on site by adjusting the adjustment gasket, so as to make the levelness on site less than or equal to the preset standard levelness, the second result is used to control a display to show an installation position and a designed size of the shear wall, and instruct the construction personnel to operate according to information shown on the display.

2. The construction method of the modular shear wall based on double-face superposed shear wall according to claim 1, wherein the step of outputting the second result, wherein the second result is used to control the display to show the installation position and the designed size of the shear wall, and instruct the construction personnel to operate according to the information shown on the display, further comprising:
sending the designed size of each component of the shear wall to a manufacturer's server to instruct the manufacturer to produce each component of the shear wall;
obtaining a first manufacturing error of each component of the shear wall according to an actual size of each component of the shear wall and the designed size of each component of the shear wall; and
determining whether the first manufacturing error meets a requirement, if yes, sending a first control command, wherein the first control command comprises an instruction of controlling the display to show information that each component of the shear wall is qualified for installation.

3. The construction method of the modular shear wall based on double-face superposed shear wall according to claim 1, wherein after the step of sending the first control command, wherein the first control command includes the instruction of controlling the display to show information that each component of the shear wall is qualified for installation, the method further comprises:
installing each component of the shear wall on a large formwork platform, and leveling and reinforcing the installation through a fixation adjustment fixture, wherein the installation of each component of the shear wall comprises a lap joint of sidewalls and a bottom plate, a lap joint of the sidewalls and a top plate, and a connection between the sidewalls, and the connection between the sidewalls comprises a connection of a first double-face superposed shear wall and a bay window, a connection of the first double-face superposed shear wall and a second double-face superposed shear wall, a splicing of the second double-face superposed shear wall and a first single-piece wall, a splicing of the first single-piece wall and a second single-piece wall, and a splicing of the second single-piece wall and the first double-face superposed shear wall; and
after the installation of the components is completed, sending a second control command, wherein the second control command comprises an instruction to control the display to show information that the installation of the components of the shear wall is completed and on-site assembling is permitted.

4. The construction method of the modular shear wall based on double-face superposed shear wall according to claim 3, wherein steel plates are pre-embedded around a window opening of the first double-face superposed shear wall, and steel plates are also pre-embedded in a recess of the bay window; the bay window and the first double-face superposed shear wall are installed in place and are fixed by welding the steel plates of the first double-face superposed shear wall and the bay window; ends of an indoor side of an inner wall of the first double-face superposed shear wall and the second double-face superposed shear wall are respectively pre-embedded with full-length steel plates along its height in vertical direction, and the first double-face superposed shear wall and the second double-face superposed shear wall are fixed by welding the pre-embedded steel plates; the second double-face superposed shear wall is connected with the first single-piece wall by welding the full-length steel plates pre-embedded in ends of an outdoor side, the first single-piece wall is connected with the second single-piece wall by welding the full-length steel plates pre-embedded in ends of the outdoor side, and the second single-piece wall is connected to the first double-face superposed shear wall by welding the full-length steel plates pre-embedded in ends of an outdoor side.

5. The construction method of the modular shear wall based on double-face superposed shear wall according to claim 3, wherein bent steel bars for a lap joint extend out from a bottom part of the first single-piece wall and the second single-piece wall, and the bent steel bars are fixed with the steel bars of a bottom plate by the lap joint.

6. The construction method of the modular shear wall based on double-face superposed shear wall according to claim 3, wherein straight steel bars for a lap joint extend out from the first double-face superposed shear wall and the second double-face superposed shear wall, and a bottom part of the first double-face superposed shear wall and the second double-face superposed shear wall are respectively provided with grooves, after the first double-face superposed shear wall and the second double-face superposed shear wall are manufactured, the steel bars for the lap joint are bent, the first double-face superposed shear wall and the second double-face superposed shear wall are respectively connected to a group of bottom plates, and the two groups of bottom plates are formed by secondary concrete pouring.

7. The construction method of the modular shear wall based on double-face superposed shear wall according to claim 3, wherein steel plates are arranged at intervals of 600 mm-800 mm on a top part of each sidewall and around ends of the top plate, to install the top plate, a fixed adjustment fixture is configured to provide support for the top plate, after the steel plates on the top part of the sidewall are welded with the steel plates around the ends of the top plate, the fixed adjustment fixture is removed to assemble the shear wall.

8. The construction method of the modular shear wall based on double-face superposed shear wall according to claim 7, wherein an interior of the shear wall is provided with an ALC partition wall, and the bottom plate at a position where the ALC partition wall is installed is provided with a flashing.

9. The construction method of the modular shear wall based on double-face superposed shear wall according to claim 3, wherein the step of sending the second control command, wherein the second control command comprises the instruction to control the display to show the information that the installation of the components of the shear wall is completed and on-site assembling is permitted further includes:
adjusting the elevation of the installation position of the shear wall by adjusting the adjustment gasket and arranging a bed-mortar layer on the installation position of the shear wall, wherein a range of the bed-mortar layer is a region of projection of the sidewall of the shear wall; installing the shear wall from a corewall to outside in a radiative manner; then assembling U-shaped steel bars and placing a running surface;
wherein two rows of connection steel plates are respectively preset between a left group and a right group of shear walls, and anchor bars of the two rows of connection steel plates penetrate deep into the interior of the shear walls, the two rows of connection steel plates are vertically lowered while the left group and right group of shear walls are installed without mutual interference, after the two rows of connection steel plates are installed in place, a gap ranged 20 mm-30 mm is left between the left group and right group of shear walls, the two rows of connection steel plates are correspondingly provided with pin holes, and pins are inserted into the pin holes along the gap to establish a double steel plate pin joint node, and staggered annular stirrups are preset in inner wall joint nodes of a combination of the left group and right group of shear walls, and a row of tie screws are arranged per 1000 mm-12000 mm to form a staggered annular stirrup connecting tie joint.

10. The construction method of the modular shear wall based on double-face superposed shear wall according to claim 10, wherein an upper group and a lower group of shear walls are connected by long U-shaped reinforcement bars arranged at intervals, an open end of each long U-shaped reinforcement bar faces downward, and short U-shaped reinforcement bars are supplemented in addition to the long U-shaped reinforcement bars, an open end of each short U-shaped reinforcement bar faces upward, and straight reinforcement bars are provided at an inner side of the short U-shaped reinforcement bars, and the straight reinforcement bars pass through a plurality groups of the short U-shaped reinforcement bars;
an edge component at a corner of each shear wall comprises two double-face superposed shear walls, stirrups are preset at end parts of the two double-face superposed shear walls, the stirrups of the two double-face superposed shear walls are overlapped and joined together, and the two double-face superposed shear walls are spliced together by welding preset steel plates, wherein an overlapping area of the stirrups of the two double-face superposed shear walls is provided with full-length connecting U-shaped reinforcement bars; and
stirrups at coupling beams of the two groups of shear walls are staggered, and the stirrups on beam surfaces of the coupling beams are assembled beforehand before leaving the factory, after installation of the two groups of shear walls, additional steel bars are arranged at intervals at the coupling beams of the top plate.
